(19) United States
(12) Patent Application Publication
(10) Pub. No.: US 2016/0052140 A1
(43) Pub. Date: Feb. 25, 2016

(54) ROBOT DRIVEN BY MOBILE PHONE

(71) Applicant: BO LI, (US)

(72) Inventor: Bo LI, Shanghai (CN)

(21) Appl. No.: 14/655,203

(22) PCT Filed: Dec. 19, 2013
(86) PCT No.: PCT/CN2013/089984

§ 371 Date: Nov. 2, 2015

(30) Foreign Application Priority Data
Dec. 24, 2012 (CN) 201210569921.0

(51) Int. Cl. B25J 13/00; H04W 88/06; B25J 5/00; H04M 1/725

(52) U.S. Cl. CPC B25J 13/006; H04M 1/7253; H04W 88/06; H04M 1/72569; B25J 5/00

(57) ABSTRACT

A robot system driven by mobile phone comprises a slave mobile phone for collecting robot information and processing the information; a central interface unit for signal processing conversion between the universal interface of the slave mobile phone and the mechanism component; an executing component for executing the command sent by the slave mobile phone; a master mobile or a remote control computer for remote control, by using a wireless network, sending command to the slave mobile phone and receiving information feedback from the slave mobile phone; input devices carried by the master mobile and the remote control computer as well as additional auxiliary input devices; and functional software of the slave mobile phone, the master mobile phone and the remote control computer. The robot system driven by mobile phone can be used to control a robot remotely, and can be popularized easily in homes in large scale.

### TECHNICAL FIELD

The present disclosure relates generally to the field of communications and automatic control, and more particularly, to a controlled means driven by mobile phone, and the control system including two mobile phones or one mobile phone and a computer.

### BACKGROUND ART

With the development of communications technology, especially smart phone and wireless networks, it is very easy to realize remote video communication and remote control by using mobile phones at present. Taking advantage of the technology, one mobile phone can act as the brain, eyes, ears, mouth, nose of a robot, the peripherals of the mobile phone act as the body of the robot, such as the arms and the sense organs. This mobile phone is controlled by another mobile phone, so the robot can be remotely controlled.

### DISCLOSURE OF THE INVENTION

### Technical Problems

Traditional robots are very expensive, because of their high development costs and the non-versatility of modules and interfaces, which is not beneficial to industrial development. Meanwhile, the functions of universal interface of the mobile phone are not exploited enough. It is quite possible to use interfaces of a mobile phone, such as USB, the earphone, Bluetooth and the like, to control the movement of the external device.

### Technical Solution to the Problems:

### Technical Solution

The present disclosure provides a system in which it is able to control a slave mobile phone by a master mobile phone or a remote control computer to drive the operation of electromechanical equipment connected to the slave mobile phone. At the slave mobile phone, using a unified standard interface, different types of mobile phones can control a plurality of robotic equipments with the standard interface. The mobile phone is used as the “brain”, “eyes”, “ears”, “mouth” of the robot, i.e., “head” of the robot, to control the robot body to operate. Due to the versatility of the mobile phone's functions and standardization of the interfaces, it is possible to send control commands to the circuit of the robot body through the USB interface, earphone interface or Bluetooth interface, by customizing the mobile phone software, modifying the driver of the USB and redefining the interface module of the earphone, thus a robot with customized modules can be realized, making the cost low and facilitating to be popularized easily in homes in large scale.

Specifically, the following modules are mainly designed:

1) a “central interface unit” for converting a universal interface signal of the slave mobile phone, wherein the interface signal of the slave mobile phone is converted into a drive signal of the electromechanical equipment, and the external electromechanical signal is converted into identifiable signal of the mobile phone interface, so that it is possible to control the electromechanical equipment through the slave mobile phone and transmit information of sensing device to the salve mobile phone.

2) a dedicated control software for a master mobile phone and a dedicated control software for a remote control computer, which achieve the functions mainly including “graphic simulation touch control” for the executing components (controlled means) of a slave mobile phone, so that the operation of the executing components of the slave mobile phone can be simulated on the screen of the master mobile phone, wherein the instructions are sent to it by touching. Here alternatives of the touch-control mode can be selected from a parameter configuration mode, an analog handle simulation mode or a key simulation-control mode. The dedicated control software is divided into two parts, one is a synchronization module between mobile phones, and as platform software, the software version is more stable, and the other is customized software for executing mechanism, designed specially and published by internet.

3) dedicated controlled service software for the slave mobile phone, which is configured so that the control signal sent from the master mobile phone or a remote control computer can be correctly received by the slave mobile phone and reaches the “central interface unit”, which in turn controls operation of the executing components.

4) dedicated executing mechanism software for the slave mobile phone, which achieves the functions mainly including “graphic simulation touch control” for the executing components of a mobile phone, so that operation of the executing components can be simulated on the screen of the mobile phone, wherein commands are, by touching, sent to the executing components of the mobile phone. There is a simple interface with the “dedicated control software” and the “controlled service software”, ensuring the control commands sent by the master mobile phone to be executable. Alternatives of the touch-control mode can be selected from a parameter configuration mode, an analog handle simulation mode or a key simulation-control mode.

5) an integrated mechanism hardware integration design of an execution robot, wherein a loudspeaker and a microphone are switched on through an audio interface of the mobile phone, for simulating the sounding and the hearing of a person; a camera and a driven shaft of the mobile phone are used as an imaging device for simulating vision; the executing components are driven wheels and mechanical limbs and the like, for simulating limbs; sensors can be in the wired connection to the “central interface unit” or wirelessly connected to the mobile phone for simulating a plurality of sensation.

6) interfaces of the “central interface unit” for series and parallel networking between the units, by which the organization of the series and parallel networking can be performed, achieving a plurality of network layouts and controlling a plurality of executing components synchronously or asynchronously.

7) a dedicated monitoring software customized by a mobile phone, for monitoring the signal of the input interface of the mobile phone, wherein after installing the software in the mobile phone, the signal sensed by the executing mechanism, such as the robot, and the environment sensing signal are transformed, using the “central interface unit”, into a mobile phone resolvable signal which is feedback to the mobile phone, the external status of the executing components and environmental situation are simulated by the software of mobile phone.

8) a shaft installed, wherein the mobile phone drives the shaft via the “central interface unit”, which can make the mobile phone rotated by 360°, such that the capturing scope of the camera of the mobile phone is not limited to one orientation; and two non-parallel shafts are designed, which can control the mobile phone to perform the all-round monitoring, simulating “actively looking around” of a person.

9) a wireless module added into the executing components, wherein by means of wirelessly communicating with the mobile phone, the mobile phone wirelessly controls the executing component, and the executing component can report information wirelessly to the mobile phone; and a movable component is added to the sensor, the movable component is capable of executing actions after receiving a wireless control instruction from the mobile phone.

Actually, a tablet computer can take the role of the slave mobile phone.

### Beneficial Effects of the Invention

### Beneficial Effects

After entering the aging society, it is a problem for some families to care for the parents of the husband and wife if both are the only child in his or her family. Products developed from this technology can achieve visualization of a virtual person, simulate communication and interaction between the operator and the elder at the distal, and realize remotely caring for the elderly in empty-nest family.

Taking full advantage of the popularity of mobile phones, versatility of interfaces and customization of software, a mobile phone system is used to substitute the “core” of a robot, so as to reduce the cost of the robot, but substantially increase the degree of customization, the interface is universal and standardized, the development of software is very easy, which explores a civilianization path for the future robot industry.

In regard of replacement of old mobile phones, this technology can make full use of disused or backup mobile phones in home, realizing reuse of resources, and also making the cost of the product low.

### BRIEF DESCRIPTION OF DRAWINGS

FIG. 1 is an illustrative diagram of the robot driven by mobile phone.

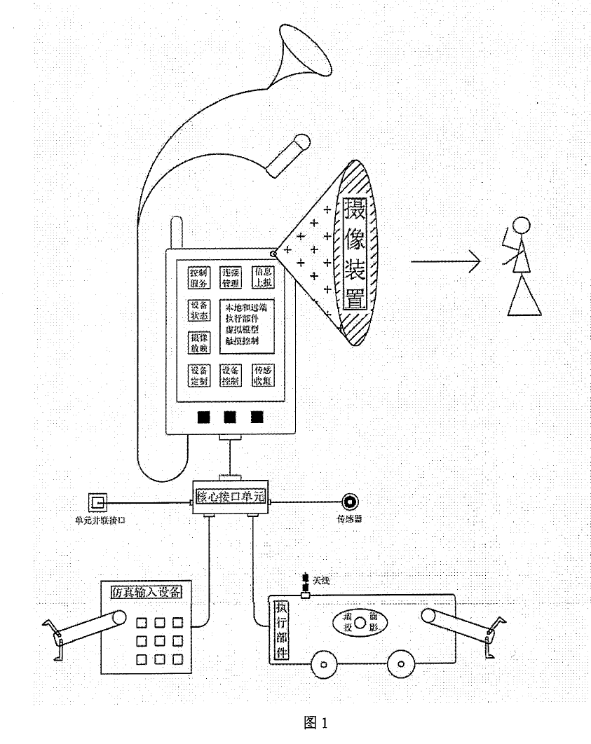

FIG. 2 is an illustrative diagram of communication between the master mobile phone or remote control computer and the slave mobile phone, which includes a schematic view showing the mobile phones receive the sensing signals remotely.

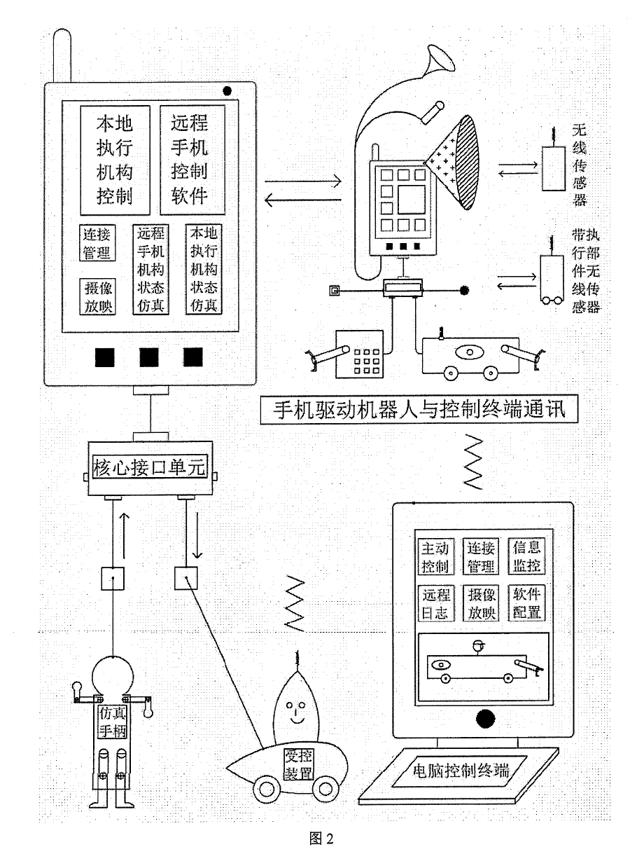

FIG. 3 is an embodiment of the robot driven by mobile phone, named “Rabbit type communication robot”.

### DETAILED DESCRIPTION OF EMBODIMENTS

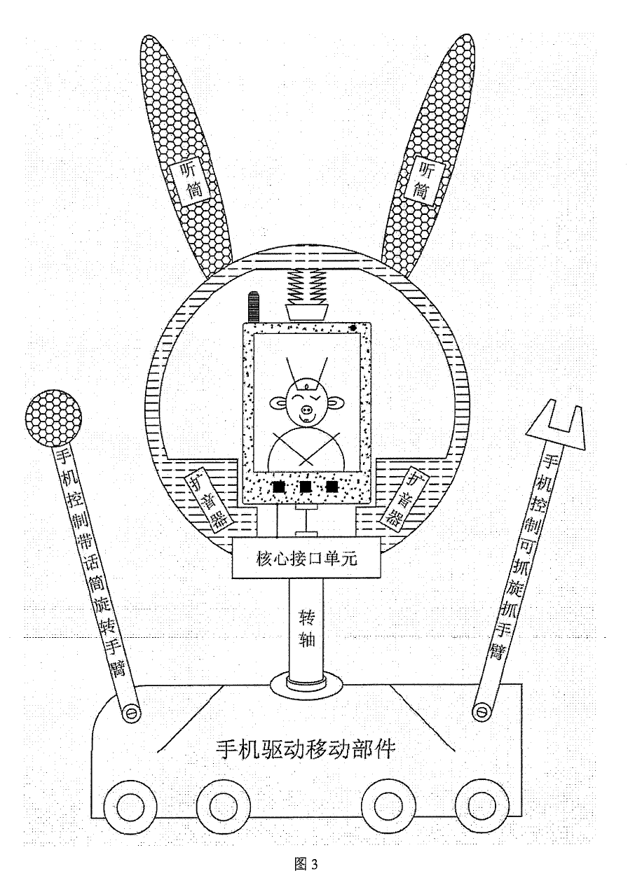

In order to illustrate the embodiments of the present disclosure more vividly, referring to the “Rabbit type communication robot” in FIG. 3, the key points in the implementation are as follows: bus interface of the slave mobile phone.

After putting such a robot on a dining table of an empty-nest elderly who is in thousands of miles away from you, by using a master mobile phone or remote control computer in your hand, it is able to achieve the following functions:
1) Your voice can be transferred loudly to ears of the elder through the loudspeaker of the robot.
2) The voice from the elder, which is not loud enough, can be transferred to you through the master mobile phone after being amplified by the earphone and transferred by the salve mobile phone.
3) The elder can see your image on the screen of the salve mobile phone, or your video can be played for the elder on the salve mobile phone.
4) The rotatable shaft can be rotated, allowing the camera of the salve mobile phone to observe the circumstances surrounding the elder with 360° omnibearing, the videos and images are transferred to the master mobile phone.
5) A remote controllable driven wheel can make the robot move to a given position according to requirements.
6) The function of the controllable and rotatable arm can be customized, wherein in this case, that is a microphone and a grab structure, but also possibly a spoon, a scratcher, a broom, a touch stick, a stress spring or the like.
7) By touching simulation images in a touch screen of the master mobile phone, a command signal can be generated, wherein for example, the rotation of the arm can be controlled by lifting a virtual arm in the touch screen of the master mobile phone, and the rotation of rotatable shaft of the robot can be controlled by rotating the head of the virtual machine.

### EMBODIMENTS OF THE INVENTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure.
“A Household chatting robot”, in which a base is formed by using a toy tank, which has a customized circuit and interfaces, the upper portion of the tank can rotate with respect to the lower portion thereof and is provided with a slot for fixing a mobile phone; as long as a mobile phone is inserted into the slot and connected to the circuit interface of the toy tank through a USB interface, and the software of the mobile phone is opened, it is possible to control this toy tank in home through a control terminal (mobile phone or computer) anywhere in the world, so as to make it shift position; the mobile phone is turned so that the camera can acquire images in different directions; there is a loudspeaker on the toy tank, and it is possible to connect the earphone jack of the mobile phone to the loudspeaker. In this way, it is possible to open the control terminal whenever desired, to drive the device to reach the elderly, who always sits on a couch and is unable to move freely, to check his/her condition, talk with him/her, and divert him/her. You see and hear the elder just like you sit in front of him or her; while the elder can feel your presence, your voice, and your look, and the most important thing is your initiative action and mind.
A “Little rabbit robot”, which is formed by re-designing the appearance based on the “household chatting robot”, wherein the appearance is similar to a rabbit, with ears of the rabbit as a microphone, the mouth of the rabbit designed as a loudspeaker, the neck of the rabbit as a rotatable device, and legs of the rabbit as four driving wheels; a mobile phone is fixed to the face of the rabbit, and this design makes the person who is chatting feel more warm; and the appearance of this “little rabbit robot” can also be produced as looking like any person by modular customization, so that a person really feels the presence of another person chatting face to face with him/her.
A “family service and back massaging robot”, the product of which has more enhanced functions with respect to the “household chatting robot”. It can fetch items, serve water, massage the back of body and the like for an elder under the remote control of a control terminal, by designing software of a mobile phone with enhanced functions, customizing a circuit board of the toy tank, reforming the structure of the toy tank, and adding “arms” in the front, back, left and right of the “household chatting robot”.
A “tall rod childcare robot”, being characterized in that a one-meter long telescopic rod is provided on a base, which is the base of the “household chatting robot”, and a circuit interface and a mobile phone holding device are provided on the upper end of the rod, wherein when a family has a baby and it is worried that the baby sleeps in bed by herself/himself, before you go out from the room, a mobile phone can be placed on the rod and connected through a USB interface. Generally, it is possible to use a conveniently carried mobile phone to control the device to perform a moving monitoring at home. When finding that the baby needs to be taken care of, the rod can be extended over the head of the baby, such that the screen of the mobile phone displays your face to talk with the baby and make the baby joyful, and cartoons such as “pleasant goat and grey wolf” can also be played for attracting the baby's attention. This equipment has a simplified version in which the rod may be secured at its one end to a headboard or the wall of the room, with the rod capable of swinging, and the other end of the rod can drive the mobile phone to rotate.
A “robot acting as a substitute in conferences (a conference substitute robot)”, which comprises: a chassis with an axle, capable of moving on a conference table; rotatable members, located on the chassis for fixing a mobile phone; a chassis circuit; a mobile phone and its software; and a control terminal (a mobile phone or computer) and its software. The mobile phone on the “conference substitute robot” is equipped with software, which can respond to a control request from other control terminals in three ways by classifying the number of the control terminal or other identification numbers. The three ways are of: permitting directly, refusing directly or selecting by pressing a button manually. When a telephone conference is held, this “conference substitute robot” acts as a substitute for a person, who cannot be present while must participate in the conference, as long as the mobile phone is installed with dedicated software, fixed to the chassis, and connected with the chassis circuit via the USB interface. The condition of the conference room, the blackboard and slide showing and the like can be viewed by controlling the “conference substitute robot”, and information may be pointed to by controlling a rotatable light pen on the chassis. The “conference substitute robot” can move on the conference table to face to a person to be discussed separately, to make a secret discussion, and so on.
A “driving assistance robot”, in which when your spouse is driving a car with your child sitting in the second-driver seat, an electromechanical component, which can rotate in the horizontal direction and the pitching direction, rather than an ashtray, is placed in the ashtray slot of the car. And, a mobile phone is fixed on this electromechanical component, and you can turn on your mobile phone at home to make a video conversation with your child through the mobile phone for attracting his attention for the purpose of preventing him from influencing your spounse's concentration on driving. When your child is not within the range of a video camera, you can touch the screen of the mobile phone by sliding your finger and remotely control the rotation of the mobile phone driving electromechanical component in the car to see your child again. Of course, it can also be used to speak with the driver, observe status of the driver, look at scenes in front of the car, and inform the driver of danger, and the like. In a upgraded version of the product, it can be connected to an on-board computer via a USB interface and sent the vehicle condition information, location information and the like acquired by the on-board computer to another mobile phone as a monitor terminal.
A “mobile phone assisting area-monitoring helicopter”, in which a mobile phone is placed at the bottom and the front of the helicopter, a security personnel of a community, through a wireless network, can use a control terminal (a mobile phone or computer) to control the helicopter to regularly patrol in the community, and make the helicopter fly to a designated location in the community at any time to capture a video in the air without being found by criminals, and send back to the control terminal. This “mobile phone assisting area-monitoring helicopter”, in case of emergency, can also fly under control into the floor where a fire hazard happens, to detect the status of the floor or deliver messages through a loudspeaker. It may also be applied in special occasions, such as talking with a person who threatens to jump off a building, negotiating with hijacking persons in close range, and carrying explosives to attack criminals.
A “student companion robot”, in which on the basis of an upgraded version of a “dining-table companion robot”, arms are additionally provided on the body, with the arms capable of pressing keyboards of a computer and performing the gripping and fondling actions. As long as one party fixes onto the upper part of the body its mobile phone which is connected with the body through a USB interface and starts the application program, a certain person can be allowed to control this “student companion robot” on the desk through a mobile phone or computer, to see a movie together with said one party, watch said one party playing games or writing documents. If necessary, it is possible to control the body to move, for completing typing at the keyboard of a computer by the arms and other actions. This product mainly faces to young students and lovers, with its appearance customized especially, wherein a reserved surface may be designed for students to stick pictures of loved person or self-portraits, as an “ever prepared substitute”. The body is provided with a loudspeaker connecting with an earphone interface. When a student cannot come to the classroom due to a leg problem, his classmate may carry such a “student companion robot” to be placed on a desk, such that the student can control this “student companion robot” as a “substitute” of himself by a computer in the dormitory. The mobile phone can be rotated to see around and can move the arm to point in a direction to ask a question.
A “outdoor companion robot”, in which when you climb a mountain or enjoy a scene, you hope your family may see and hear, and here the most important is to actively experience. At this time, you can wear a special travel cap, which has a rotatable cap top. As long as a mobile phone is fixed thereon and the USB interface is plugged in, your family can, through a mobile phone or computer at home, control the mobile phone on your head to rotate and look around, observing through the pitching movement the ground and the sky. “Arms” on both sides of the travel cap can be controlled to point in different directions, indicating to you which side has more beautiful view. When sitting down due to getting tired, you can take off the cap and put it on the opposite side, for chatting with the other person, just like the other person being personally on the scene.
A “mobile phone music colorful lamp”, wherein a string of lights with 21 colors can be customized, representing 21 musical scales, these lights are controlled by an interface circuit board, and an input of the circuit board is the earphone port of a mobile phone. You can use a mobile phone to send the name of a song to your girlfriend's mobile phone. When the earphone interface of her mobile phone is connected to that interface circuit board, these colorful lights can flash according to the rhythm of the music. These colorful lights can be embedded in gift toys such as a flower basket and the like, or stuck around a display device of a computer, creating environment atmosphere. When rescuing a disaster, devices like this colorful lamp can well applied in an area in which infrastructure cannot be deployed timely. Each mobile phone is installed with the software. The mobile phone, acting as a control terminal, directionally sends a message or performs the group-sending in broadcasting mode. When other mobile phones receive a specific message, the colorful lights connected to the earphone interface can be made to perform different combinations of flashing, visibly conveying some information or commands.
A “light-shadow dancing robot”, which is developed on the basis of the “mobile phone music colorful lamp”, wherein a circuit interface for an axle and a linkage is additionally provided on the circuit. While the lights are controlled to flash by an audio file, the rotation speed of the driving wheels and the jumping rhythm of the linkage can be controlled simultaneously, just like dancing. A music score can also be self-made by software, such a “music score” is equivalent to a command for batch process, so the brightness and blinking of the lights can be controlled and a machinery is controlled to enter different operating conditions chronologically, achieving the light-shadow effects.

A “undercover robot”, which is obtained by reforming a pistol, wherein a mobile phone is used as a part of the pistol and can control the movement, rotation and firing of the pistol. This reformed device is fixed somewhere, and can make a certain level of rotation to point into different directions, so as to remotely control to attack criminals. In the military, any mobile phone can be used to receive signals via the public wireless network, greatly improving concealment, and it can be used all-day and difficult to be discovered.

The principles and features of this invention may be employed in various and numerous embodiments without departing from the scope of the invention.

### INDUSTRIAL APPLICATION

Because of the popularity of mobile phones and development of robot devices and wireless networks, the present invention is very easy for industrial productions and applications.

1. A robot system driven by mobile phone, comprising: (1) a slave mobile phone to collect information, play video and audio information, receive, send, and process information, (2) a controlled means to execute the instruction sent by the slave mobile phone, (3) a central interface unit to process the conversion of signals exchanged between the universal interface of the salve mobile phone and the controlled means, (4) a master mobile phone or a remote control computer, via the wireless networks, to control the slave mobile phone, and get feedback information from the salve mobile phone, (5) input means of the master mobile phone, or the remote control computer, (6) functional software of the salve mobile phone and the master mobile phone, or, function software of the salve mobile phone and the remote control computer, wherein the system is divided into the following subsystems:
a) a local control subsystem, wherein the slave mobile phone is connected, through its universal interface, with the central interface unit via a data link, and sends signals to the central interface unit to control the operation of said controlled means connected to the central interface unit;
b) a remote control subsystem, wherein with the master mobile phone or the remote control computer as a controller, using a dedicated control software in the controller, the slave mobile phone is controlled via a wireless network, such that the slave mobile phone sends signals to the central interface unit according to the manner specified by the controller, and the controlled means is driven by using the central interface unit;
c) an auxiliary input subsystem of the master mobile phone or the remote control computer, wherein the master mobile phone or the remote control computer is connected, through its universal interface, with the central interface unit via a data link, so as to obtain the signals of the input device connected to the central interface unit;
d) a local wireless control and sensing subsystem, wherein the salve mobile phone, through its wireless communication module, directly drives the controlled means, which can receive wireless signals, or receives wireless sensing signals sent by said controlled means; and
e) a remote signal and information feedback subsystem, wherein the master mobile phone or the remote control computer is works as a monitor, the slave mobile phone is connected with the monitor via a wireless network using a dedicated monitoring software in the monitor, the monitor receives sensing signals that the salve mobile phone generates or detects by itself, or by using the central interface unit, or by using the controlled means, and receives video and image information taken by the slave mobile phone.

2. The robot system driven by mobile phone according to claim 1, wherein said central interface unit, which can be a chip, a dedicated circuit board, a single chip microcomputer or a dedicated computer, is configured for converting an interface signal of mobile phone into an external driving signal, and converting an external signal into an interface signal of mobile phone, wherein the central interface unit is connected to an universal interface of the mobile phone at one end and connected to the controlled means at the other end.

3. The robot system driven by mobile phone according to claim 1, wherein said controlled means is electromechanical equipment, including wheel shaft, motor, mechanical arm, and projector, especially including wheel electric mobile device, wherein said salve mobile phone is mounted on the controlled means and move with the controlled means.

4. The robot system driven by mobile phone according to claim 1, wherein said input means is button, operating lever, touch control screen, optical input device, or miniature.

5. The robot system driven by mobile phone according to claim 1, wherein the supported communication standard of said salve mobile phone, said master mobile phone and said remote control computer is one or more of the following: infrared, Bluetooth, WLAN, Wi-Fi, GSM, GRPS, EDGE, 3G, WiMAX, LTE and LTE-A; and wherein in said local wireless control and sensing subsystem, the supported communication standard of the salve mobile phone communicates directly with said controlled means through their wireless communication modules is one or more of the following: infrared, Bluetooth, and visible light.

6. The robot system driven by mobile phone according to claim 1, wherein said sensing signal including: photoelectric, voltage, current intensity, humidity, temperature, light intensity, sound volume, and pressure.

7. The robot system driven by mobile phone according to claim 1, wherein said robot system contains an integration of three or more components, which are selected from loudspeaker, microphone, shooting apparatus, controlled means and sensor.

8. The robot system driven by mobile phone according to claim 1, wherein the central interface unit contains interfaces for series and parallel networking between units, and a plurality of network layouts can be obtained by the organization of series and parallel connection, so as to control a large number of controlled means synchronously or asynchronously.

9. The robot system driven by mobile phone according to claim 1, wherein said central interface unit receives the control command of said salve mobile phone to control the electromechanical shaft of the controlled means, making the salve mobile phone move, so that the camera of the salve mobile phone can take images in different directions.

10. A robot system driven by mobile phone, comprising a common design mode which integrates all features of claims 1 to 9 or combination of features of some of the claims, wherein the types of robot referring to this mode includes humanoid robot driven by mobile phone, remote control toy driven by mobile phone, model car driven by mobile phone, small helicopter driven by mobile phone, motor vehicle driven by mobile phone, and controllable electromechanical component driven by mobile phone.
